(19) United States
(12) Patent Application Publication
(10) Pub. No.: US 2014/0129461 A1
(43) Pub. Date: May 8, 2014

(54) Crowdsourced Vendor Information

(71) Applicant: Pradeep Chauhan, Bellevue, WA (US)

(72) Inventor: Pradeep Chauhan, Bellevue, WA (US)

(21) Appl. No.: 13/669,466

(22) Filed: Nov. 6, 2012

(51) Int. Cl. G06Q 10/06

(52) U.S. Cl. 705/321

(57) ABSTRACT

Disclosed is, among other things, techniques to obtain information about client companies, staffing firms, and jobs, which may allow contractors to find the work they desire more efficiently.

### FIELD

This disclosure relates to Crowdsourced Vendor Information.

### BACKGROUND

Companies often have approved vendors that they use to purchase goods and services from but they don't disclose or publish this information. This information may be useful to other vendors that may interested in finding potential customers for their goods or services or stakeholders such as investors, analysts, or consumers.

Similarly, many companies use contractors to augment regular staff. This allows the client company flexibility in staffing volumes and allows appropriate expertise to be used when needed. These client companies often use staffing companies to recruit for contractors, which may relieve the extra load on internal human resources departments, may reduce co-employment risks, may reduce costs, and may reduce administrative overhead.

Staffing companies advertising for contractors may not display the underlying client company for several reasons, or the staffing company may list an alias for the client company. For example, the client company may not want their name used in advertisements, or the staffing company may not want people or competitors to know who the client company is.

Contractors may have preferences for what client companies they would like to be working in, but may have to speak to a recruiter or apply to learn who the client company is.

### SUMMARY

The instant application discloses, among other things, techniques to obtain information about client companies, staffing firms, and jobs, which may allow contractors to find the work they desire more efficiently.

For example, a contractor may have a preference to work for Boeing™. Often job postings by staffing companies will not disclose who the client company is, so it may be difficult for the contractor to effectively target jobs of interest. Contacting the staffing company or applying for the job may result in discovering the client company, but being able to filter jobs prior to contacting or applying may save time and frustration for both the contractor and the staffing company.

An application may be used to display information about client companies and their approved staffing companies, which they may use to hire contractors, while allowing entry of information that may be of interest to potential contractors, for example: a client company, a staffing company, skills they hire, wage ranges, workplace reviews of the client or staffing companies, or specific work locations. This information may then be available for other people to see.

In another embodiment, information about job openings may be shared, including information not in the original job posting, such as the client company name, which may have been crowdsourced.

These techniques may also be used by vendors, for example, to determine appropriate client companies to target if they wish to place their goods and services in those client companies.

### BRIEF DESCRIPTION OF THE DRAWINGS

FIG. 1 illustrates a system capable of supporting Crowdsourced Vendor Information, according to one embodiment.

FIG. 2 illustrates a job listing with information being requested, according to one embodiment.

FIG. 3 illustrates a job listing with information displayed, according to one embodiment.

FIG. 4 illustrates a user interface to allow searching for client companies with job openings, according to one embodiment.

FIG. 5 illustrates a user interface to allow searching for staffing companies with positions to place, according to one embodiment.

FIG. 6 illustrates a user interface displaying staffing companies used by a particular client company.

FIG. 7 illustrates a user interface displaying Approved Vendors used by a particular client company.

FIG. 8 illustrates a component diagram of a computing device according to one embodiment.

### DETAILED DESCRIPTION

A more particular description of certain embodiments of Crowdsourced Vendor Information may be had by references to the embodiments shown in the drawings that form a part of this specification, in which like numerals represent like objects.

Crowdsourcing is a process involves giving a task to a group of people, usually the general public, not employees.

The instant application discloses, among other things, techniques to obtain information about client companies, staffing firms, and jobs, which may allow contractors to find the work they desire more efficiently.

These techniques may also be used by suppliers, for example, to determine appropriate vendor companies to target if they wish to place their products in particular companies by seeing who the approved vendors are.

For example, a contractor may have a preference to work for Boeing™. Often job postings by staffing companies will not disclose who the client company is, so it may be difficult for the contractor to effectively target jobs of interest. Contacting the staffing company may result in learning the client company, but being able to filter jobs prior to contacting may save time and frustration for both the contractor and the staffing company.

An application may be used to display job openings, while allowing entry of information that may be of interest to potential contractors, for example: the client company, wage ranges, or specific work locations. This information may then be available for other people to see.

In another embodiment, information about vendors may be shared, including such information as which vendors are preferred by particular companies.

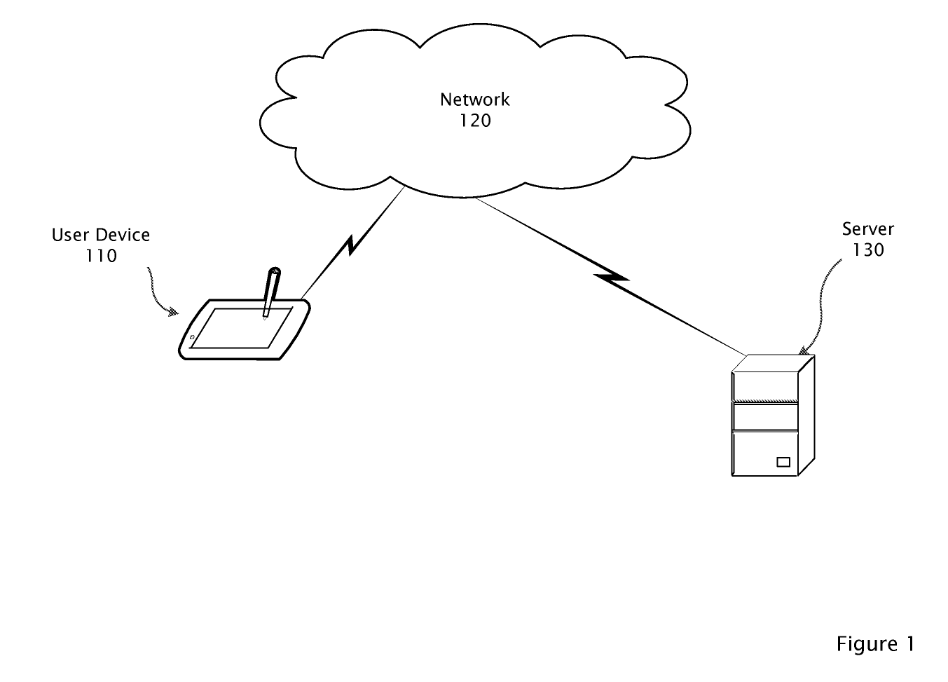

FIG. 1 illustrates a system capable of supporting Crowdsourced Vendor Information according to one embodiment. For example, when a contract job is posted without information that may be of interest to potential contractors, such as company name, salary ranges, or other job attributes, a user may provide some of the missing information.

For example, a contracting company in the Redmond, Wash. area may post a job for a software developer for a local software company. Since there are many companies, both large and small, in the area, a contractor may not know if the posting is for a position at Microsoft. Some contractors may wish to be placed at Microsoft, while others may prefer smaller companies. If another potential contractor has called about the position, that contractor may update information in the job post to indicate it is at Microsoft. This allows other contractors to not apply if they are not interested in the position, thereby reducing the calls the contracting company receives from people who are not interested in the actual job.

Server 130 may provide a web page, a native application, or other user interface to provide a way for a contractor to indicate the client company. Server 130 may communicate via Network 120, which may be a local area network, wide area network, Bluetooth, or other way to communicate, to User Device 110. User Device 110 may subsequently display the user interface to allow the contractor to enter the information.

Server 130 may accept, store, and return information about a contracting job. Server 130 may include one or more computers.

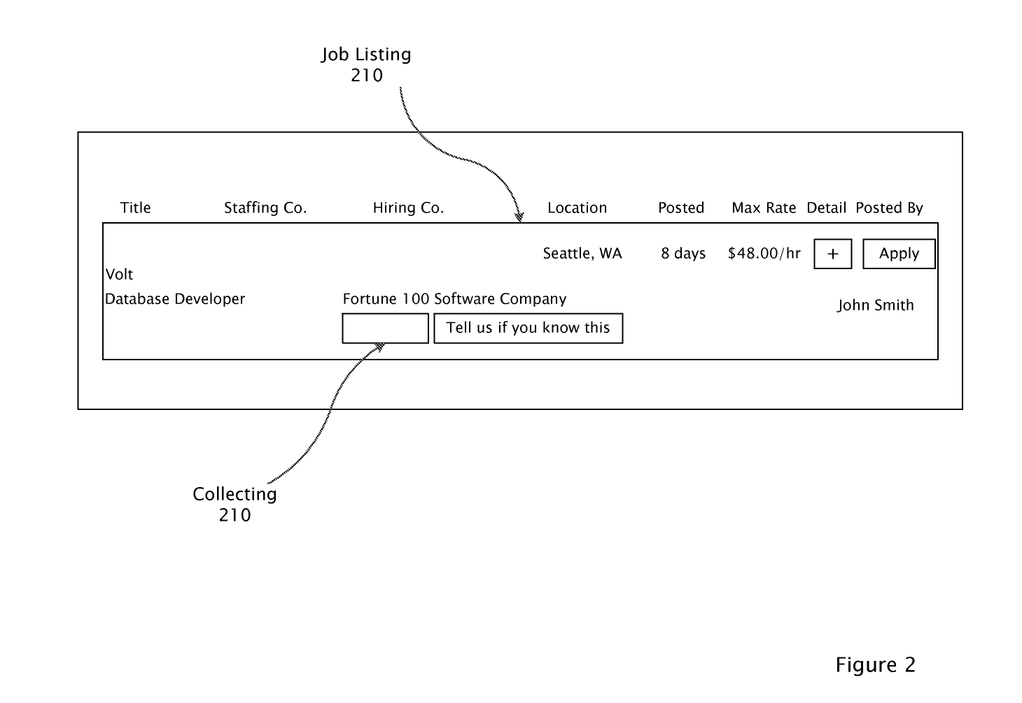

FIG. 2 illustrates a job listing with Crowdsourced Vendor Information being requested according to one embodiment.

Job Listing 210 may display information about an available job, including the job title (in this example, Database Developer), a staffing company listing the job (in this example, Volt), the client company (in this example, Fortune 100 Software Company), and other information—where the job is, how long it has been posted, how much it pays, who listed it, and so on.

Below the client company, a Collecting 210 text box is displayed, with a caption next to it asking “Tell us if you know this.” A contractor who has talked to a staffing company about the job may know and may type the name of the client company in the text box.

In addition to the client company, other information may also be requested. For example, if a range of a rate of pay is not known (in FIG. 2 it was provided as a maximum of $48.00/hr), a text box may be provided to allow entry of that information. Other information that may be requested may include a the name of a staffing company; what skills the client company is seeking; type of contractor, such as developer, accountant, SAP, or marketing; a type of staffing company; a staffing company location; a client company location; a billing rate; a pay rate; a type of pay, such as weekly, hourly, monthly; title within the client company; a rating for the staffing company or the client company; and a review for the staffing company or the client company; or other information.

By providing this information, a contractor may help other contractors target their job search more efficiently, or may help other staffing companies find potential client companies.

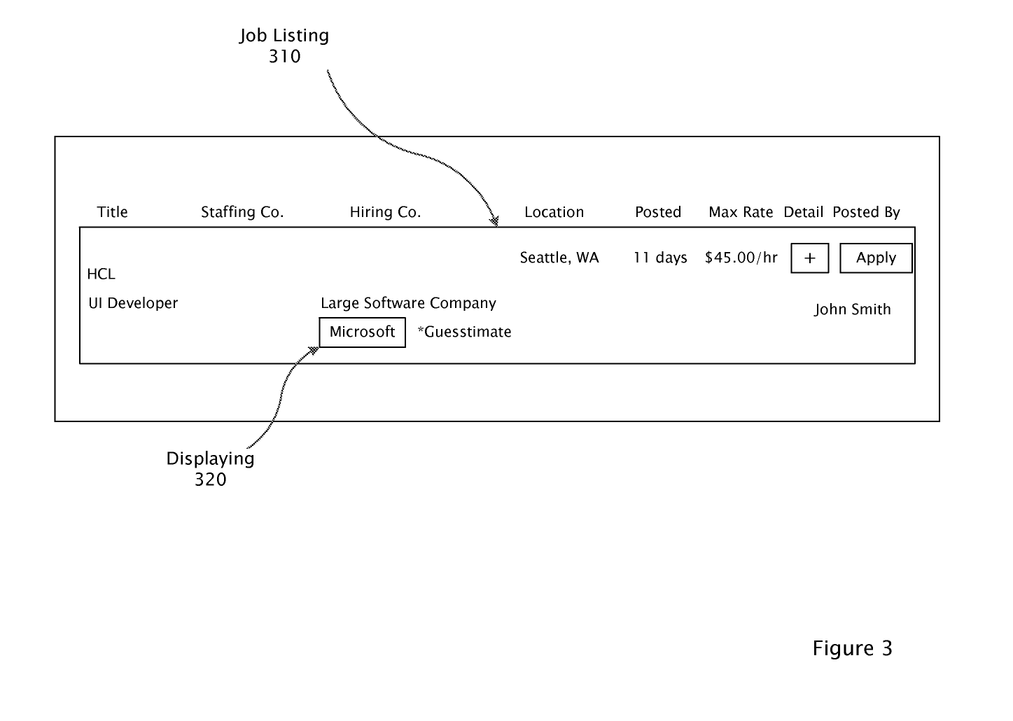

FIG. 3 illustrates a job listing with Crowdsourced Vendor Information displayed according to one embodiment. Job Listing 310 may display information about an available job, including the job title (in this example, UI Developer), a staffing company listing the job (in this example, HCL), the client company (in this example, Large Software Company), or other information—where the job is, how long it has been posted, how much it pays, who listed it, and so on.

In this example, Displaying 320 a text box has “Microsoft” as a value. It is indicated that this is a guesstimate, meaning it was not provided as part of the job listing, but rather was provided by a contractor who may have spoken to the staffing company about the job.

One having skill in the art will recognize that other layouts may be used to display and collect the data illustrated in the examples shown in FIG. 2 and FIG. 3. The user interfaces may be from a web page, a native application, or any other way of displaying and allowing input from a user. In the examples shown herein, the information displayed may be held on Server 130. In other embodiments, information may be stored on a different system, or spread over several systems.

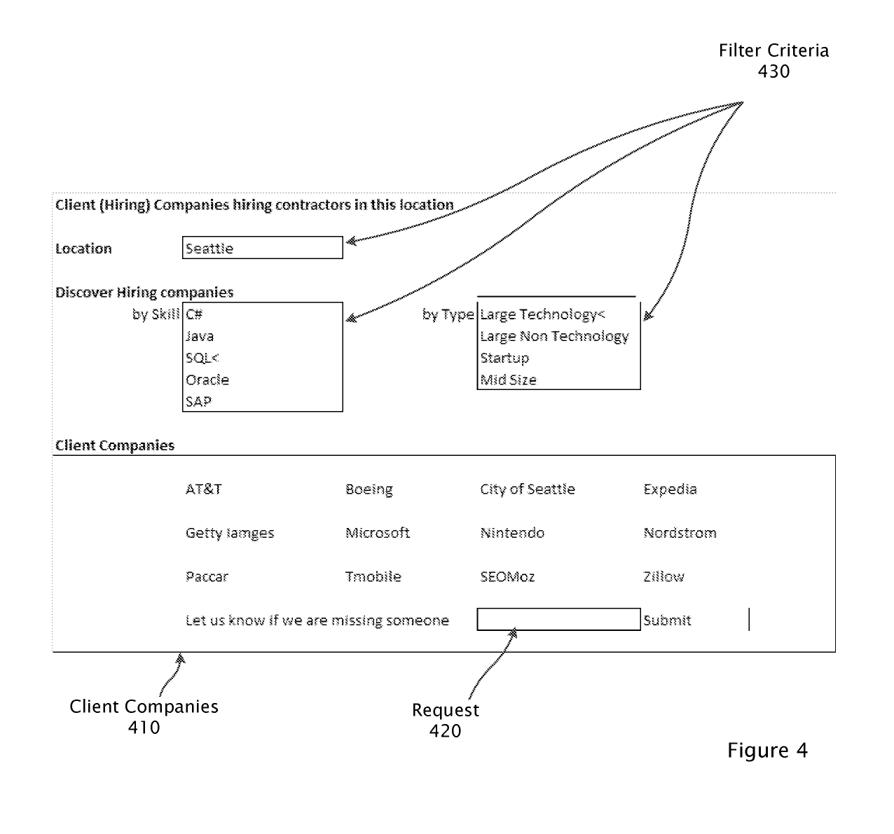

FIG. 4 illustrates a user interface to allow searching for client companies, according to one embodiment. This may allow a contractor with specific skills find client companies who hire for those skills. It may also allow a contractor to find companies fitting a particular profile of interest.

Filter Criteria 430 may allow a user to filter client companies using information about a type of environment the user desires. In this example, Filter Criteria 430 includes location, skill, and company classification. In another embodiment, other Filter Criteria may be included, such as rate of pay, ratings of a client company, and reviews of client companies.

A list of Client Companies 410 meeting the Filter Criteria 430 may be displayed. Request 420 invites the user to enter additional companies that meet Filter Criteria 430.

One having skill in the art will recognize that many filter criteria may be used to determine appropriate Client Companies 410, and that a user interface may allow choosing one or more filtering options.

One having skill in the art will also recognize that information in addition to a client company name may be requested.

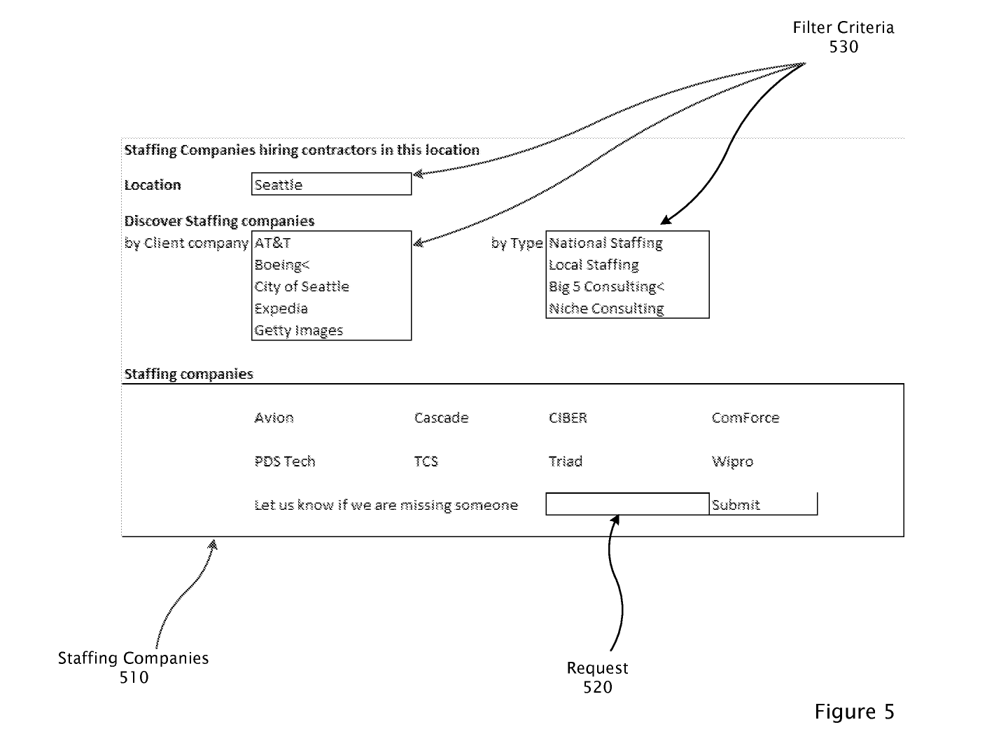

FIG. 5 illustrates a user interface to allow searching for staffing companies with positions to place, according to one embodiment. This may allow, for example, a contractor wishing to work at Expedia a way to see which staffing companies Expedia uses, so that the contractor may focus on job listings posted by those staffing companies.

Filter Criteria 530 may allow a user to filter staffing companies using information about the type of environment the user desires. In this example, Filter Criteria 530 includes location, skill, and company classification. In other embodiments, other filter criteria may be used.

Staffing Companies 510 may then display staffing companies meeting Filter Criteria 530. Request 520 invites the user to enter additional companies that meet Filter Criteria 530.

One having skill in the art will recognize that many filter criteria may be used to determine appropriate Staffing Companies 410, and that a user interface may allow choosing one or more filtering options, such as rate of pay, a rating of the staffing company, and a review of the staffing company.

One having skill in the art will also recognize that information in addition to a staffing company name may be requested.

In another embodiment, Crowdsourced Vendor Information may be used by a supplier to identify a new potential client by seeing who their preferred vendors are to get goods or services into a particular purchasing company. For example, if a supplier sees that a competitor is a preferred vendor, the purchasing company may be a potential client for the supplier.

One having skill in the art will recognize that many different types of information relating to vendors, goods and service providers, and purchasing or client companies may be obtained by crowdsourcing, and that many different ways of obtaining and sharing that information may be implemented in various embodiments.

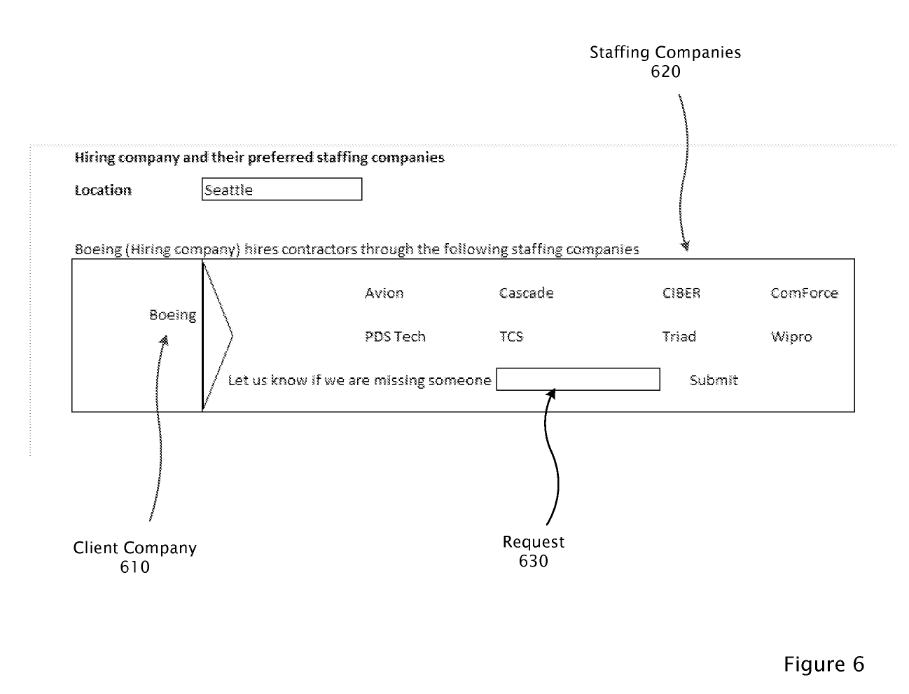

FIG. 6 illustrates a user interface displaying staffing companies used by a particular client company. In this example, Client Company 610 Boeing uses Staffing Companies 620 Avion, PDS Tech, Cascade, TCS, CIBER, Triad, ComForce, and Wipro. Request 630 allows a user to add additional Staffing Companies 620 if additional staffing companies are known.

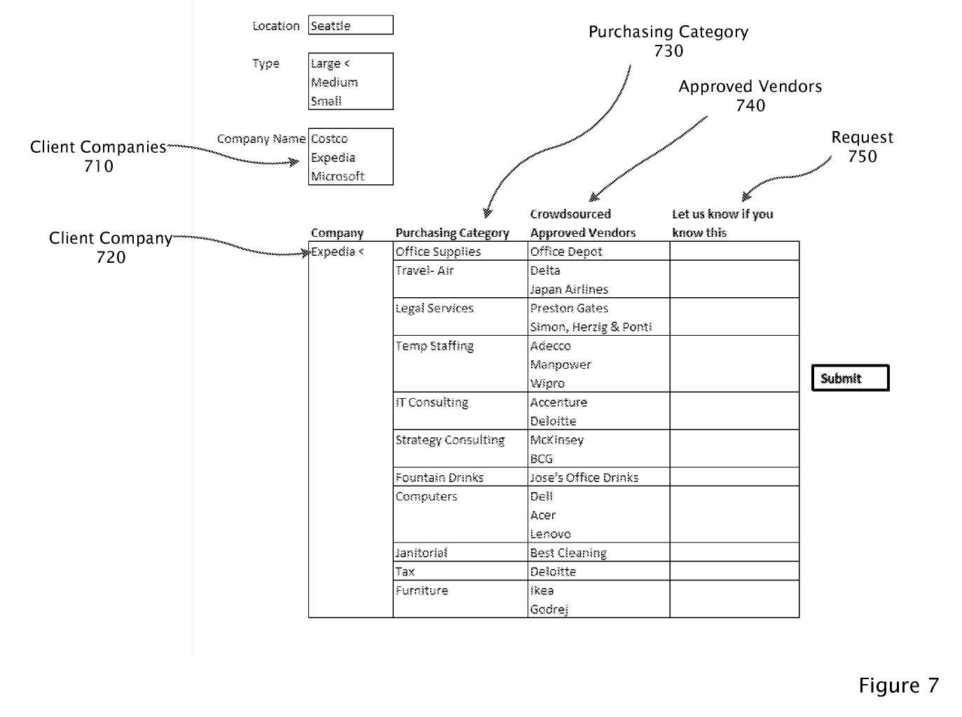

FIG. 7 illustrates a user interface displaying Approved Vendors used by a particular client company. In this example, Expedia is selected from a filtered list of Client Companies 710. The selected company is shown in Client Company 720. In another embodiment, multiple Client Company 720 may be shown in a list. Purchasing Category shows various categories of items Client Company 720 purchases, with Approved Vendors 740 showing known vendors used by Client Company 720 for the purchasing category. Request 750 allows for input of additional Approved Vendors 740 used by the Client Company 720.

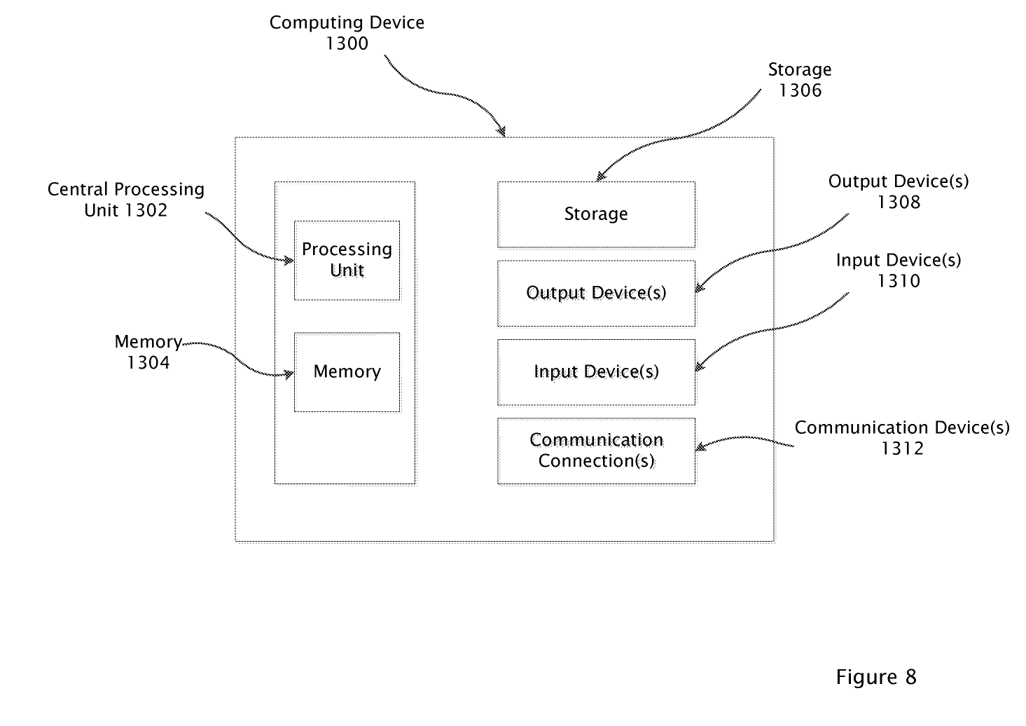

FIG. 8 illustrates a component diagram of a computing device according to one embodiment. The Computing Device (1300) can be utilized to implement one or more computing devices, computer processes, or software modules described herein, including, for example, but not limited to User Device 110, or a Server 130. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by a User Device 110, or a Server 130. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer storage media includes volatile and nonvolatile, removable and non-removable media implemented in any method or technology for storage of information such as computer readable instructions, data structures, program modules or other data. Memory (1304) and Storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A system, comprising:
a processor;
a memory coupled to the processor;
components operable by the processor, comprising:
a data storage component, configured to store data;
a query receiving component, configured to receive a query;
a requesting component, configured to request data from a user;
a responding component, configured to respond to the received query with data stored by the data storage component, the response from the responding component including data received from a user; and
a data storing component, configured to store data received from a user in the data storage component.

2. The system of claim 1, wherein the requested data is selected from a group comprising: the name of a client company, the name of a staffing company, skills, type of contractor, type of staffing company, staffing company location, client company location, a bill rate, a pay rate, a type of pay, title, rating, and a review.

3. The system of claim 1, wherein the requested data is selected from a group comprising: the name of a client company, the name of a vendor, vendor location, client company location, the name of a good, the name of a service, quantity, price, a review, and a rating.

4. The system of claim 1 wherein the user interacts with the requesting component through a web page.

5. The system of claim 1 wherein the user interacts with the requesting component through a native software application.

6. A computer-implemented method, comprising:
requesting data from a first user;
receiving data from the first user in response to the request;
receiving a query for data from a second user; and
returning data to the second user, the returned data including the data received form the first user.

7. The method of claim 6, wherein the requested data is selected from a group comprising: the name of a client company, the name of a staffing company, skills, type of contractor, type of staffing company, staffing company location, client company location, a bill rate, a pay rate, a type of pay, title, rating, and a review.

8. The method of claim 6, wherein the requested data is selected from a group comprising: the name of a client company, the name of a vendor, vendor location, client company location, the name of a good, the name of a service, quantity, price, a review, and a rating.

9. The method of claim 6 wherein the second user is a contractor seeking work.

10. The method of claim 6 wherein the second user is a vendor looking for a client company as a potential customer.

11. A computer readable storage medium having stored thereon instructions which, when executed by a processor, execute a method, comprising:
requesting data from a first user;
receiving data from the first user in response to the request;
receiving a query for data from a second user; and
returning data to the second user, the returned data including the data received form the first user.

12. The method of claim 6, wherein the requested data is selected from a group comprising: the name of a client company, the name of a staffing company, skills, type of contractor, type of staffing company, staffing company location, client company location, a bill rate, a pay rate, a type of pay, title, rating, and a review.

13. The method of claim 6, wherein the requested data is selected from a group comprising: the name of a client company, the name of a vendor, vendor location, client company location, the name of a good, the name of a service, quantity, price, a review, and a rating.

14. The method of claim 6 wherein the second user is a contractor seeking work.

15. The method of claim 6 wherein the second user is a vendor looking for a client company as a potential customer.
